(19) United States
(12) Patent Application Publication
(10) Pub. No.: US 2025/0061873 A1
(43) Pub. Date: Feb. 20, 2025

(54) CONSONANT LENGTH CHANGING DEVICE, ELECTRONIC MUSICAL INSTRUMENT, MUSICAL INSTRUMENT SYSTEM, METHOD, AND PROGRAM

(71) Applicant: CASIO COMPUTER CO., LTD., Shibuya-ku, Tokyo (JP)

(72) Inventors: Makoto DANJYO, Tokyo (JP); Fumiaki OTA, Tokyo (JP); Atsushi NAKAMURA, Tokyo (JP)

(73) Assignee: CASIO COMPUTER CO., LTD., Shibuya-ku, Tokyo (JP)

(21) Appl. No.: 18/721,380

(22) PCT Filed: Dec. 2, 2022
(86) PCT No.: PCT/JP2022/044629

§ 371 Date: Jun. 18, 2024

(30) Foreign Application Priority Data
Dec. 21, 2021 (JP) 2021-207131

(51) Int. Cl. G10H 5/00; G10L 21/043; G10L 25/00

(52) U.S. Cl. CPC G10H 5/005; G10L 21/043; G10L 25/00; G10H 2250/505

(57) ABSTRACT

An onset length changing device includes at least one processor configured to: perform a process of advancing a first vocal generation start timing of a first vowel in a certain syllable including a first consonant and a second vocal generation start timing of a second vowel in a syllable including a second consonant that is different from the certain syllable, based on a parameter designated in response to one user operation; and not to change a vocal generation start timing of a vowel in a syllable without including a consonant.

### TECHNICAL FIELD

The present disclosure relates to a consonant length changing device, an electronic musical instrument, a musical instrument system, a method, and a program.

### BACKGROUND ART

There has been an electronic musical instrument that proceeds the lyrics in response to a key press operation by the user (performer), and outputs a synthesized voice corresponding to the lyrics (see, for example, Patent Literature 1).

### CITATION LIST

### Patent Literature

Patent Literature 1: JP2016-184158A

### SUMMARY OF INVENTION

### Technical Problem

During keyboard performance with this type of electronic musical instrument w % bile proceeding the lyrics, the rise of vocal generation (the time from the start of a syllable to the start of the vowel of the syllable) differs depending on the types of syllables included in the lyrics. If the rise of vocal generation is different for each syllable, for example, it is difficult for the user to perform on the keyboard while maintaining a constant rhythm and proceeding the lyrics.

The present invention has been made in view of the above circumstances, and an object of the present invention is to provide a consonant length changing device, an electronic musical instrument, a musical instrument system, a method, and a program capable of reducing a difference in the rise of generation of each syllable.

### Solution to Problem

A consonant length changing device according to one embodiment of the present invention includes at least one processor. The processor is configured to: perform a process of advancing a first vocal generation start timing of a first vowel in a certain syllable including a first consonant and a second vocal generation start timing of a second vowel in a syllable including a second consonant that is different from the certain syllable, based on a parameter designated in response to one user operation; and not to change a vocal generation start timing of a vowel in a syllable without including a consonant.

### Advantageous Effects of Invention

According to one embodiment of the present invention, it is possible to reduce a difference in the rise of generation of each syllable in a consonant length changing device, an electronic musical instrument, a musical instrument system, a method, and a program.

### BRIEF DESCRIPTION OF DRAWINGS

FIG. 1 is a block diagram illustrating a configuration of a musical instrument system according to an embodiment of the present invention.

FIG. 2 is a block diagram illustrating a configuration of the electronic musical instrument according to the embodiment of the present invention.

FIG. 3 is a block diagram illustrating a configuration of an information processing device according to the embodiment of the present invention.

FIG. 4 is a diagram illustrating a functional block group for executing voice synthesis in the embodiment of the present invention.

FIG. 5A is a diagram for explaining information of a frame included in lyrics parameters according to an embodiment of the present invention.

FIG. 5B is a diagram for explaining the effect exerted in the embodiment of the present invention.

FIG. 6 is a flowchart illustrating the processing of a program executed by a processor of the information processing device according to the embodiment of the present invention.

FIG. 7 is a subroutine illustrating the details of the processing in a singing voice generation mode of step S102 of FIG. 6.

FIG. 8 is a subroutine illustrating the details of key press processing of step S202 of FIG. 7.

FIG. 9 is a subroutine illustrating the details of consonant offset processing according to Embodiment 1 of the present invention, which is consonant offset processing of steps S310 and S311 of FIG. 8.

FIG. 10 is a subroutine illustrating the details of consonant offset processing according to Embodiment 2 of the present invention, which is the consonant offset processing of steps S310 and S311 of FIG. 8.

FIG. 11 is a subroutine illustrating the details of vocal generation of step S203 of FIG. 7.

FIG. 12 is a subroutine illustrating the details of the key press processing of step S202 of FIG. 7 according to a modification of the present invention.

FIG. 13 is a subroutine illustrating the details of play rate acquisition of steps S703 and S704 of FIG. 12.

### DESCRIPTION OF EMBODIMENTS

A musical instrument system according to an embodiment of the present invention will be described in detail with reference to the drawings. In the following description, an example of the musical instrument system is a system including an electronic musical instrument and an information processing device.

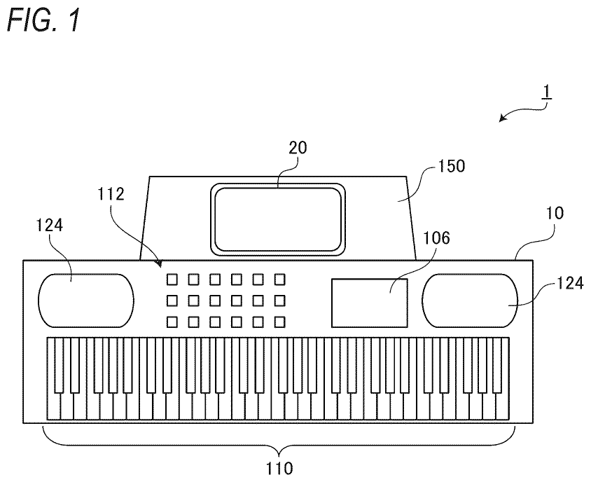

FIG. 1 is a block diagram illustrating a configuration of a musical instrument system 1 according to an embodiment of the present invention. As illustrated in FIG. 1, the musical instrument system 1 includes an electronic musical instrument 10 and an information processing device 20. The electronic musical instrument 10 and the information processing device 20 are connected in a wireless or wired manner to communicate with each other.

In the present embodiment, the electronic musical instrument 10 is an electronic keyboard including a keyboard 110. The electronic musical instrument 10 may be an electronic keyboard instrument other than an electronic keyboard, or may be an electronic percussion instrument, an electronic wind instrument, or an electronic stringed instrument.

The information processing device 20 is a tablet terminal. The information processing device 20 is placed on, for example, a music stand 150 of the electronic musical instrument 10. The information processing device 20 may be a device of another form such as a smartphone, a laptop PC (which is an abbreviation for Personal Computer), a stationary PC, or a portable game machine.

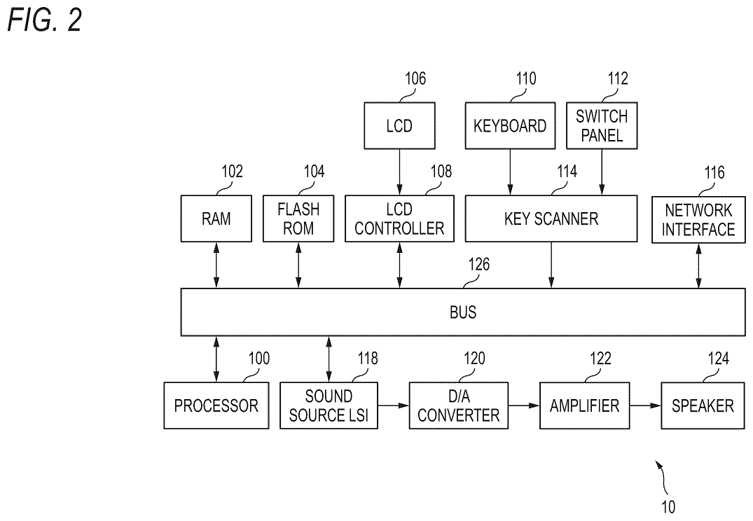

FIG. 2 is a block diagram illustrating a configuration of the electronic musical instrument 10 according to the embodiment of the present invention. The electronic musical instrument 10 has a hardware configuration including a processor 1W, a RAM (which is an abbreviation for Random Access Memory) 102, a flash ROM (which is an abbreviation for Read Only Memory) 104, an LCD (which is an abbreviation for Liquid Crystal Display) 106, an LCD controller 108, a keyboard 110, a switch panel 112, a key scanner 114, a network interface 116, a sound source LSI (which is an abbreviation for Large Scale Integration) 118, a D/A converter 120, an amplifier 122, and a speaker 124. The units of the electronic musical instrument 10 are connected to a bus 126.

The processor 100 reads programs and data stored in the flash ROM 104, and comprehensively controls the electronic musical instrument 10 by using the RAM 102 as a work area.

The processor 100 is, for example, a single processor or multiple processors, and includes at least one processor. In a case of a configuration including multiple processors, the processor 100 may be packaged as a single device, or may include a plurality of devices physically separated inside the electronic musical instrument 10.

The RAM 102 temporarily stores data and programs. The RAM 102 stores the programs and data read from the flash ROM 104, and also data necessary for communication.

The flash ROM 104 is a nonvolatile semiconductor memory such as a flash memory, an EPROM (which is an abbreviation for Erasable Programmable ROM), or an EEPROM (which is an abbreviation for Electrically Erasable Programmable ROM), and plays a role as a secondary storage device or an auxiliary storage device.

The LCD 106 is driven by the LCD controller 108. When the LCD controller 108 drives the LCD 106 in accordance with a control signal from the processor 100, a screen corresponding to the control signal is displayed on the LCD 106. The LCD 106 may be replaced with a display device such as an organic EL (which is an abbreviation for Electro Luminescence) or an LED (which is an abbreviation for Light Emitting Diode). The LCD 106 may be a touch panel. In this case, the touch panel is also a part of the switch panel 112.

The keyboard 110 is a keyboard having a plurality of white keys and a plurality of black keys as a plurality of performance operators. The respective keys are associated with different pitches.

The switch panel 112 includes mechanical, capacitive non-contact, or membrane operators, such as switches, buttons, knobs, rotary encoders, wheels, or touch panels.

The key scanner 114 monitors key press and key release on the keyboard 110 and operations on the switch panel 112. When detecting key press operation by the user, for example, the key scanner 114 generates a key press event and outputs the key press event to the processor 100. The key press event includes, for example, pitch data on a key related to the key press operation. When detecting a key release operation by the user, for example, the key scanner 114 generates a key release event for stopping generating the sound corresponding to the key press operation and outputs the key release event to the processor 100.

The processor 100 instructs the sound source LSI 118 to read corresponding waveform data from a plurality of pieces of waveform data stored in the flash ROM 104. The waveform data to be read is determined in response to, for example, the key press event and the tone selected according to the operation on the switch panel 112 by the user.

The sound source LSI 118 generates a musical sound based on the waveform data read from the flash ROM 104 under the instruction from the processor 100. The sound source LSI 118 includes, for example, 128 generator sections, and can simultaneously generate 128 musical sounds at the maximum.

The digital voice signal of the musical sound generated by the sound source LSI 118 is converted into an analog signal by the D/A converter 120, amplified by the amplifier 122, and output to the speaker 124. As a result, a musical sound of the key-pressed pitch is played.

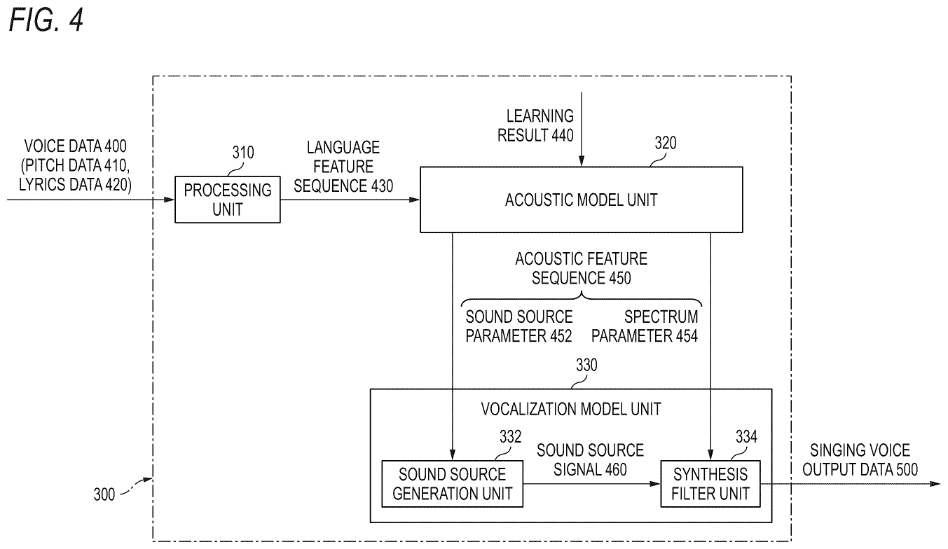

The network interface 116 is an interface for communicating with various external devices including the information processing device 20. For example, the processor 100 can transmit an event to the information processing device 20 connected via the network interface 116, and receive singing voice output data 500 (see FIG. 4; details will be described later) from the information processing device 20. The singing voice output data 500 received via the network interface 116 is converted into an analog signal by the D/A converter 120, and then is amplified by the amplifier 122 and output to the speaker 124. As a result, a singing voice corresponding to the keyboard operation is played.

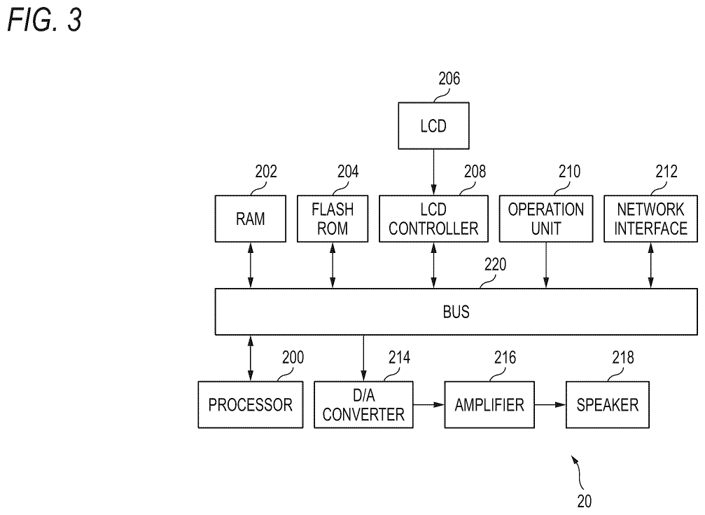

FIG. 3 is a block diagram illustrating a configuration of the information processing device 20 according to the embodiment of the present invention. The information processing device 20 includes a processor 200, a RAM 202, a flash ROM 204, an LCD 206, an LCD controller 208, an operation unit 210, a network interface 212, a D/A converter 214, an amplifier 216, and a speaker 218. The units of the information processing device 20 are connected to a bus 220.

The processor 200 reads programs and data stored in the flash ROM 204, and comprehensively controls the information processing device 20 by using the RAM 202 as a work area.

The processor 200 is, for example, a single processor or multiple processors, and includes at least one processor. In a case of a configuration including multiple processors, the processor 200 may be packaged as a single device, or may include a plurality of devices physically separated inside the information processing device 20.

The LCD 206 is driven by the LCD controller 208. When the LCD controller 208 drives the LCD 206 in accordance with a control signal from the processor 200, a screen corresponding to the control signal is displayed on the LCD 206. The LCD 206 may be a touch panel. In this case, the touch panel is also a part of the operation unit 210.

The operation unit 210 includes mechanical, capacitive non-contact, or membrane operators, such as switches or buttons. The user can set the mode of the information processing device 20 by operating the operation unit 210.

Examples of the settable mode include a normal mode and a singing voice generation mode. The normal mode is a mode in which musical sounds are generated with the tone of a musical instrument such as a guitar and a piano. The singing voice generation mode is a mode of proceeding the lyrics in response to a key press operation performed in the electronic musical instrument 10 and outputting synthesized voice corresponding to the lyrics.

The singing voice generation mode includes two mode: a mono mode and a poly mode. The mono mode is a mode in which only one voice can be generated simultaneously. The poly mode is a mode in which two or more voices can be generated simultaneously. In the present embodiment, in the mono mode, for example, the lyrics are generated by a singing voice imitating a human voice based on an acoustic model set as a learning result by machine learning. In the poly mode, the lyrics are generated with the tone of a musical instrument such as a guitar or a piano. In the mono mode, the settings of the information processing device 20 may be changed such that the lyrics are generated with the tone of a musical instrument such as a guitar or piano, and in the poly mode, the settings of the information processing device 20 may be changed such that the lyrics are generated with a singing voice imitating a human voice.

The network interface 212 is an interface for communicating with various external devices including the electronic musical instrument 10. For example, the processor 200 can receive the event from the electronic musical instrument 10 connected via the network interface 212 and transmit the singing voice output data 500 to the electronic musical instrument 10.

FIG. 4 illustrates a functional block group 300 for executing voice synthesis. The functional block group 300 may be implemented by executing a program (software) by the processor 200, which is an example of a computer, or may be entirely or partially implemented by hardware (for example, an LSI for voice synthesis) such as a dedicated logic circuit mounted on the information processing device 20.

As illustrated in FIG. 4, the information processing device 20 includes a processing unit 310, an acoustic model unit 320, and a vocalization model unit 330 as functional blocks for executing voice synthesis.

When any key of the keyboard 110 is operated, the electronic musical instrument 10 generates an event (a key press event or a key release event) corresponding to a key press operation or a key release operation, and transmits the event to the information processing device 20. The information processing device 20 performs voice synthesis according to the functional block group 300 based on the event received from the electronic musical instrument to generate the singing voice output data 500. The generated singing voice output data 500 is converted into an analog signal by the D/A converter 214, and then is amplified by the amplifier 216 and output to the speaker 218. Thus, a singing voice corresponding to the key press operation is played by the information processing device 20.

The singing voice may be played by the electronic musical instrument 10. In this case, the singing voice output data 500 generated by the functional block group 300 is transmitted to the electronic musical instrument 10. The electronic musical instrument 10 outputs the singing voice output data 500 received from the information processing device 20 from the speaker 124, thereby playing a singing voice corresponding to the key press operation.

In the present embodiment, the information processing device 20 performs voice synthesis alone, but the configuration of the present invention is not limited thereto. In another embodiment, the electronic musical instrument 10 may execute voice synthesis alone. In this case, the electronic musical instrument 10 includes the entire functional block group 300 (more specifically, a program and a dedicated hardware configuration for implementing the functional blocks).

In still another embodiment, the electronic musical instrument 10 and the information processing device 20 may share and execute voice synthesis. For example, the information processing device 20 executes the processing by the processing unit 310, and the electronic musical instrument 10 executes the processing by the acoustic model unit 320 and the vocalization model unit 330. The information processing device 20 may execute the processing by the processing unit 310 and the acoustic model unit 320, and the electronic musical instrument 10 may execute the processing by the vocalization model unit 330. It can be appropriately designed which processing is to be shared and executed by the electronic musical instrument 10 and the information processing device 20. As described above, the electronic musical instrument 10 and the information processing device 20 have a degree of freedom in performing the voice synthesis, and various design changes can be made.

In voice synthesis, the length of the consonant included in a syllable in the lyrics data 420, which is an example of lyrics information, is changed based on parameters designated in response to one user operation (more specifically, the vocal generation start timing of the vowel in each syllable including a consonant is advanced), so that the difference in the rise of generation of each syllable included in the lyrics is limited small. That is, the information processing device 20 (or the electronic musical instrument 10 or the musical instrument system 1) is an example of a consonant length changing device, and includes at least one processor. The processor: advances a first vocal generation start timing of a first vowel in a certain syllable including a first consonant and a second vocal generation start timing of a second vowel in a syllable including a second consonant that is different from the certain syllable, based on a parameter designated in response to one user operation; and does not change a vocal generation start timing of a vowel in a syllable without including a consonant. In general, a syllable include a rhyme and an onset preceding the rhyme. The rhyme includes a nucleus and a coda following the nucleus. Some syllables lack an onset, and some rhymes lack a coda. For the sake of convenience, the present disclosure assumes a language in which codas basically do not appear such as Japanese, and thus an “onset” is simply referred to as “consonant”. If assuming the presence of codas, a “consonant” may be interpreted as an “onset” and a “vowel” may be interpreted as a “rhyme”.

In the present embodiment, the processor 200, which is a single processor or multiple processors, corresponds to “at least one processor”. If the electronic musical instrument 10 performs the voice synthesis alone, the processor 100, which is a single processor or multiple processors, corresponds to “at least one processor”. If the musical instrument system 1 performs the voice synthesis as a whole (in other words, if the musical instrument system 1 is an example of a consonant length changing device), one or both of the processor 100 and the processor 200 correspond to “at least one processor”.

As illustrated in FIG. 4, voice data 400 corresponding to an operation on any key of the keyboard 110 is input to the functional block group 300. The functional block group 300 outputs singing voice output data 500 obtained by inferring a singing voice of a singer based on an acoustic feature sequence output from the acoustic model unit 320. The acoustic model is a statistical model expressing the correlation between a language feature sequence, which is a text, and an acoustic feature sequence, which is a voice. That is, the functional block group 300 executes statistical voice synthesis of synthesizing the singing voice output data 500 corresponding to the voice data 400 by prediction using a statistical model, that is, the acoustic model set in the acoustic model unit 320.

The functional block group 300 may output song waveform data corresponding to a song play position during the play of accompaniment (song data), for example. Here, the song data may correspond to accompaniment data (for example, data on the pitch, tone, and generation timing for one or more sounds), accompaniment and melody data, and may be referred to as back track data, for example.

The voice data 400 includes, for example, pitch data 410 and lyrics data 420. The voice data 400 may include information for performing the song data corresponding to the lyrics (MIDI (Musical Instrument Digital Interface) data).

The pitch data 410 is included in an event generated in response to an operation on any key of the keyboard 110. That is, pitch data 410 indicates the pitch corresponding to the operated key.

The lyrics data 420 includes information in units of phrase. A phrase includes one or more syllables. The lyrics data 420 includes lyrics information 422. The lyrics information 422 is, for example, the text of the lyrics. The lyrics information 422 includes, for example, information on the types of the syllables in a phrase (such as a start syllable, an intermediate syllable, or an end syllable), the note value, the tempo, and the meter. The text included in the lyrics information 422 may be, for example, a plane text or a text in a format conforming to a language for musical score description (for example, MusicXML). The lyrics data 420 may be information in units of syllable.

The lyrics data 420 further includes lyrics parameters 424. The lyrics parameters 424 are, for example, parameters related to the generation of each syllable included in a phrase (singing voice synthesis).

As information for each syllable, the lyrics parameters 424 include, for example, a syllable start frame, a vowel start frame, a vowel end frame, and a syllable end frame. Such information indicates the positions of the frames on the timeline when generating a sound corresponding to a syllable. Frames may be the constituent unit of a phoneme (phoneme string) or may be interpreted as another time unit. The lyrics parameters 424 may include a vocal generation timing indicating a reference timing (or offset) of each frame (syllable start frame, vowel start frame, etc.).

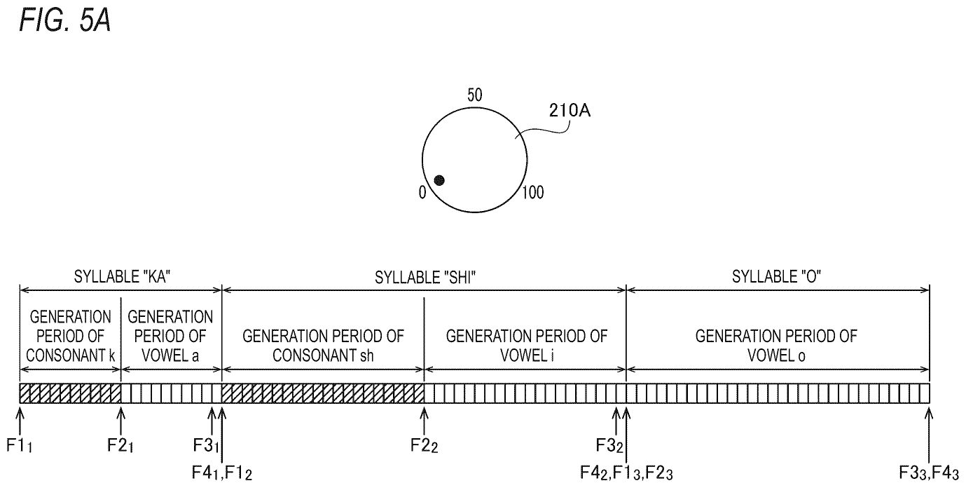

FIG. 5A is a diagram for explaining information of a frame included in the lyrics parameters 424. FIG. 5A takes a phrase including three syllables “ka”, “shi” and “o” as an example. In the present embodiment, the phrase “Kashio” indicates a family name, rather than Casio (registered trademark). In FIG. 5A, the frames forming each syllable are illustrated by a plurality of rectangles arranged in a line. This indicates that each syllable includes a plurality of frames. FIG. 5A is merely a schematic diagram and does not indicate the actual number of frames of each syllable. FIG. 5A also illustrates a schematic diagram illustrating that a consonant length adjustment knob 210A is set to zero (adjustment value: 0%), which will be described in detail later. The consonant length adjustment knob 210A is, for example, an operator in the form of a knob displayed on the touch panel screen of the information processing device 20.

In the present embodiment, the vocalization model unit 330 outputs, for example, 225 samples of singing voice output data 500 for each frame. Each frame has a time width of 5 msec. Therefore, each sample is about 0.0268 msec. Accordingly, the sampling frequency of the singing voice output data 500 is 1/0.0268 msec≈44.1 kHz.

As illustrated in FIG. 5A, the sound corresponding to a syllable (for example, one of “ka”, “shi”, and “o”) starts being generated from a syllable start frame F1, and stops being generated at a syllable end frame F4. In the syllable, the sound corresponding to the vowel starts being generated from a vowel start frame F2, and stops being generated at a vowel end frame F3. For example, the positions on the timeline of the syllable end frame F4 and the syllable start frame F1 of the next syllable are the same. If the sound corresponding to the syllable includes a consonant, the consonant normally starts being generated from the syllable start frame F1, and stops being generated immediately before the vowel start frame F2. That is, the vowel start frame F2 corresponds to the vocal generation start timing of the vowel in the syllable.

In FIG. 5A, for the sake of convenience, a subscript “1” is attached to the frames F1 to F4 corresponding to the syllable “ka”, a subscript “2” is attached to the frames F1 to F4 corresponding to the syllable “shi”, and a subscript “3” is attached to the frames F1 to F4 corresponding to the syllable “o”. As illustrated in FIG. 5A, the consonant k of “ka” is generated from the syllable start frame F1₁ to the vowel start frame F2₁, and the vowel a of “ka” is generated from the vowel start frame F2₁ to the vowel end frame F3₁. The consonant sh of “shi” is generated between the syllable start frame F1₂ and the vowel start frame F2₂, and the vowel i of “shi” is generated from the vowel start frame F2₂ to the vowel end frame F3₂. The vowel o of “o” is generated from the vowel start frame F2₃ to the vowel end frame F3₃. The vowel start frame F2₁ corresponds to a first vocal generation start timing of a first vowel in a certain syllable including a first consonant. The vowel start frame F2₂ corresponds to a second vocal generation start timing of a second vowel in a syllable including a second consonant that is different from the certain syllable.

The length of a consonant included in a syllable varies depending on the context (for example, the feature and the singing style of the singing voice of the singer as the model, the previous and subsequent lyrics, the pitch, etc.), which is a factor affecting the acoustic feature. Furthermore, the lengths of consonants differ between different sounds (for example. “ka” and “shi”), and even for the same sound (for example, the same “ka”) due to the influence of the context.

In the present embodiment, the information processing device 20 operating as a consonant length changing device controls the frames of syllables including a consonants, thereby reducing a difference in the rise of generation of the syllables included in the lyrics.

The schematic operation of the functional block group 300 will be described below.

The processing unit 310 receives the voice data 400 (that is, the pitch data 410 and the lyrics data 420). The processing unit 310 may be referred to as, for example, a text analysis unit.

The pitch data 410 is input from the electronic musical instrument 10 to the processing unit 310 in response to an operation on any key of the keyboard 110. The lyrics data 420 is acquired from, for example, a server on a network or the electronic musical instrument 10, and is input to the processing unit 310. The lyrics data 420 may be held in advance by the information processing device 20.

The processing unit 310 analyzes the input voice data 400. More specifically, the processing unit 310 analyzes, and outputs to the acoustic model unit 320, a language feature sequence 430 representing the phonemes, parts of speech, words, or the like corresponding to the voice data 400 including the pitch data 410 and the lyrics data 420.

The acoustic model unit 320 receives the language feature sequence 430 and a learning result 440. The learning result 440 is acquired from a server on a network, for example.

The acoustic model unit 320 estimates and outputs an acoustic feature sequence 450 corresponding to the input language feature sequence 430 and learning result 440. The acoustic feature sequence 450 includes sound source parameters 452 and spectrum parameters 454, which are estimated information. That is, based on the language feature sequence 430 input from the processing unit 310, the acoustic model unit 320 outputs estimated values of the sound source parameters 452 and the spectrum parameters 454 that maximize the generation probability using, for example, the acoustic model set as the learning result 440 by machine learning. The acoustic model is a learned model (learning result 440) learned by machine learning, and is expressed by model parameters calculated as a result of machine learning.

The sound source parameters 452 are information (parameters) obtained by modeling a human vocal cord. The sound source parameters 452 may be, for example, a power value and a fundamental frequency (F0) indicating the pitch frequency of human voice.

The spectrum parameters 454 are information (parameters) obtained by modeling a human vocal tract. The spectrum parameters 454 may be, for example, line spectral pairs (which is abbreviated as LSP) or line spectral frequencies (which is abbreviated as LSF) that allow efficient modeling of a plurality of formant frequencies, which are characteristics of a human vocal tract.

The vocalization model unit 330 includes a sound source generation unit 332 and a synthesis filter unit 334. The sound source parameters 452 and the spectrum parameters 454 output from the acoustic model unit 320 are input to the sound source generation unit 332 and the synthesis filter unit 334, respectively.

The sound source generation unit 332 is a functional block obtained by modeling a human vocal cord. Based on the sequence of the sound source parameters 452 sequentially input from the acoustic model unit 320, the sound source generation unit 332 generates and outputs to the synthesis filter unit 334, for example, a sound source signal 460 including: a pulse string periodically repeated with the fundamental frequency (F0) and the power value included in the sound source parameters 452 (in the case of voiced sound phonemes); a white noise having the power value included in the sound source parameters 452 (in the case of unvoiced sound phonemes); or a signal that is a mixture thereof.

The synthesis filter unit 334 is a functional block obtained by modeling a human vocal tract. The synthesis filter unit 334 forms a digital filter for modeling a vocal tract based on the sequence of the spectrum parameters 454 sequentially input from the acoustic model unit 320. The digital filter is excited by using the sound source signal 460 input from the sound source generation unit 332 as an excitation source signal. Thus, the singing voice output data 500 is output from the synthesis filter unit 334.

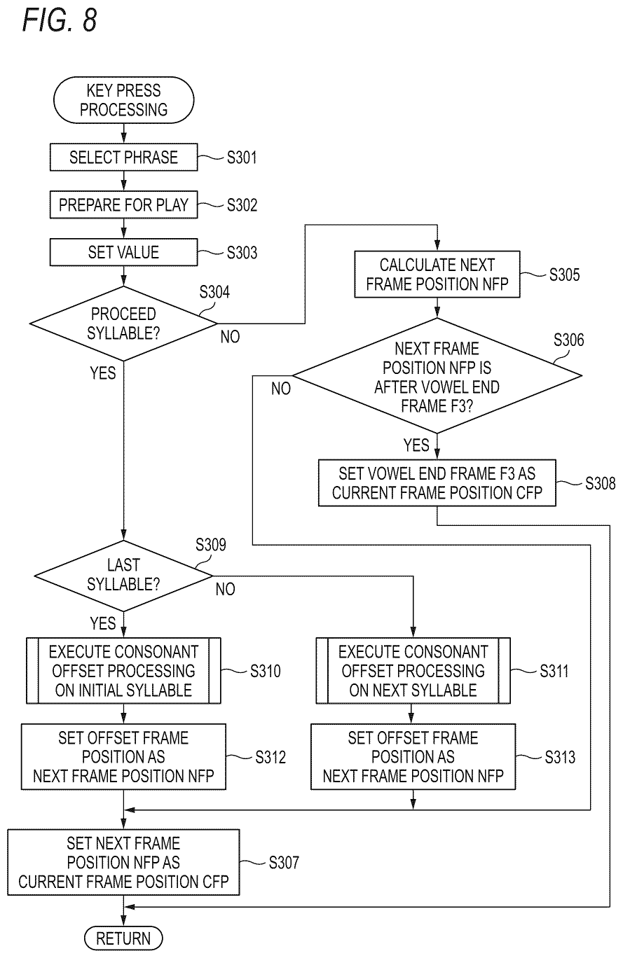

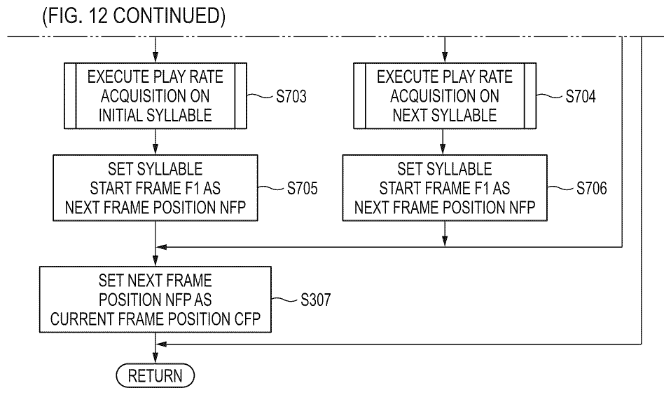

The sound source parameters 452 and the spectrum parameters 454 are parameters subjected to the processing of changing the lengths of a plurality of consonants (in the present embodiment, the length of the consonants included in each syllable included in a phrase) (a key press processing to be described later; see FIGS. 8 and 12). That is, the vocalization model unit 330 outputs the singing voice output data 500 based on the parameters in which the lengths of the plurality of consonants are changed.

Consider a case where the electronic musical instrument 10 includes the vocalization model unit 330 (the electronic musical instrument 10 includes the entire functional block groups 300). In this case, it can be said that the electronic musical instrument 10 “includes the vocalization model unit 330 configured to output the singing voice output data 500 based on the parameters in which the lengths of the plurality of consonants are changed”.

Consider a case where the information processing device 20 includes the processing unit 310 and the acoustic model unit 320 and the electronic musical instrument 10 includes the vocalization model unit 330. In this case, it can be said that the musical instrument system 1 “includes the electronic musical instrument 10 including the information processing device 20 (an example of the consonant length changing device) configured to output the parameters in which the lengths of the plurality of consonants are changed, an acquiring unit configured to acquire the parameters output from the information processing device 20, and the vocalization model unit 330 configured to output the singing voice output data 500 based on the acquired parameters”. The processor 100 operates as the acquiring unit, for example, in cooperation with the network interface 116.

The singing voice output data 500 is converted into an analog signal by the D/A converter 120, and then is amplified by the amplifier 122 and output to the speaker 124. As a result, a singing voice corresponding to the keyboard operation is played.

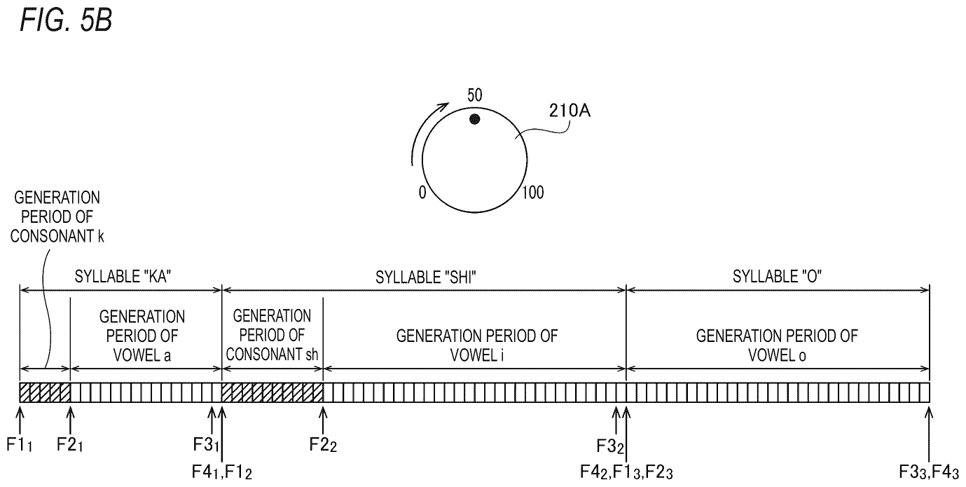

FIG. 6 is a flowchart of the processing executed by the processor 200 in cooperation with the units of the information processing device 20 including the functional block group 300. For example, when started, the system of the information processing device 20 starts executing the processing illustrated in FIG. 6. When ended, the system of the information processing device 20 stops executing the processing illustrated in FIG. 6.

As illustrated in FIG. 6, the processor 200 determines whether the system is set to the singing voice generation mode (step S101). If set to the singing voice generation mode (step S101: YES), the processor 200 executes the singing voice generation mode (step S102). If not set to the singing voice generation mode (step S101: NO), the processor 100 executes the normal mode (step S103). The processing illustrated in FIG. 6 continues being executed until the system of the electronic musical instrument 10 is ended (that is, until determined as YES in step S104).

By executing the singing voice generation mode in step S102, the difference in the rise of generation of each syllable included in the lyrics (here, phrase) is limited small. Therefore, for example, the user can easily perform on the keyboard while maintaining a constant rhythm and proceeding the lyrics.

In other words, in the singing voice generation mode, the user rotates an operator (for example, the consonant length adjustment knob 210A) to change the lengths of the plurality of consonants included in the syllables in the phrase, such that the difference in the rise of generation of each syllable included in the phrase is limited small. The operation of setting the mode of the information processing device 20 to the singing voice generation mode is an example of a user operation for changing the lengths of the consonants. The processor 200 changes the lengths of the consonants by transitioning to, and executing, the singing voice generation mode in response to a predetermined control signal (a control signal generated in response to a setting operation to the singing voice generation mode).

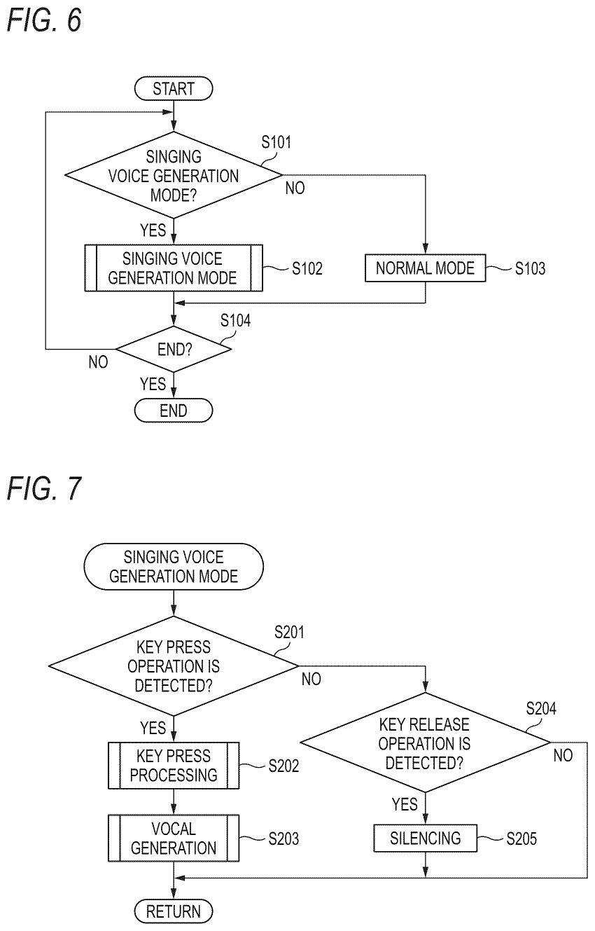

FIG. 7 is a subroutine illustrating the details of the processing in the singing voice generation mode of step S102 of FIG. 6.

The processor 200 detects a key press operation on any key of the keyboard 110 (step S201). For example, when receiving a key press event from the electronic musical instrument 10, the processor 200 detects that a key press operation is performed until a key release event including the same pitch data as the key press event is received.

If a key press operation is detected (step S201: YES), the processor 200 executes key press processing (step S202) and vocal generation (step S203) in this order. As a result, the information processing device 20 generates a singing voice in which the difference between in the rise of generation of the syllables is limited small.

If no key press operations are detected (step S201: NO), the processor 200 detects a key release operation on the key being pressed (Step S204). For example, when a key release event is received from the electronic musical instrument 10, the processor 200 detects a key release operation. If a key release operation is detected (step S204: YES), the processor 200 executes a silencing processing to stop generating the singing voice corresponding to the released key (step S205).

In the singing voice generation mode according to the present embodiment, when any one of the keys (first key) of the keyboard 110 is pressed, the phrase starts being played at a pitch corresponding to the pressed key, and the syllables in the phrase are sequentially played as long as the first key is pressed (in other words, until the first key is released). In other words, the phrase is repeatedly played as long as the first key is pressed. In the example of FIG. 5A, the three syllables “ka”. “shi”, and “o” are played sequentially and repeatedly as long as the first key is pressed.

As described above, in the present embodiment, the phrase is repeatedly played as long as the first key is pressed, but the configuration of the present invention is not limited thereto. For example, when the first key is pressed, syllables in the phrase may be sequentially played only once. In this case, for example, the last syllable (more specifically, the nucleus of the last syllable) in the phrase may be played continuously as long as the first key is pressed. Further, for example, the phrase may be silenced after a period corresponding to the velocity at the time of the key press has elapsed even if the first key continues being pressed.

The initial syllable in the phrase may be played when the first key is pressed, and the next syllable in the phrase may be played when a second key following the first key is pressed. This will be described with an example of FIG. 5A. In this case, “ka” is played when the first key is pressed, “shi” is played when the second key is pressed, and “o” is played when a third key following the second key is pressed. That is, the play for each key press is not in units of phrase but in units of syllable. Each syllable may start being played upon key press and stop being played upon key release (that is, may be continuously played during the key press), and may be silenced after a period corresponding to the velocity at the time of the key press has elapsed. Since the difference in the rise of generation of each syllable is limited small by executing the singing voice generation mode, for example, the user can easily perform on the keyboard while maintaining a constant rhythm and proceeding the syllables included in the phrase one by one.

FIG. 8 is a subroutine illustrating the details of the key press processing of step S202 of FIG. 7. The key press processing illustrated in FIG. 8 is executed by, for example, the processing unit 310 implemented by the control of the processor 200.

The processor 200 selects the phrase to be played (step S301). The phrase to be played is designated in advance by, for example, an operation by the user.

The processor 200 prepares to play the phrase (step S302). For example, the processor 200 reads the voice data 400 including the lyrics data 420 corresponding to the phrase selected in step S301.

In the present embodiment, the frames arranged on the timeline in each phrase are sequentially assigned with values. For example, the value 1 is assigned to the initial frame in the phrase, and the value 2 is assigned to the subsequent second frame. The processor 200 sets a current frame position CFP, which indicates the current vocal generation position on the timeline in the phrase, to the value 1 (step S303). In the example of FIG. 5A, the value 1 set here indicates the initial frame of the syllable “ka”.

The processing of steps S301 to S303 is executed when the key press processing of step S202 of FIG. 7 is executed for the first time on the phrase to be played. Otherwise (for example, at the second and subsequent execution of the key press processing of step S202), the processing of steps S301 to S303 is skipped.

The processor 200 determines whether to proceed the syllable to be generated to the next syllable in the phrase (step S304). For example, when the current frame position CFP reaches the vowel end frame F3 (in other words, the value allocated to the vowel end frame F3), the processor 200 determines to proceed to the next syllable. When the processing of step S304 is executed for the first time on the phrase to be played (that is, w % ben the initial syllable in the phrase is played for the first time after the key press on the first key), it is determined to proceed to the next syllable. If the syllable to be generated is the last syllable in the phrase, the initial syllable in the phrase corresponds to the next syllable in the phrase.

If not to proceed to the next syllable (step S304: NO), the processor 200 calculates a next frame position NFP to be a frame position later than the current frame position CFP on the timeline (step S305). The next frame position NFP is calculated by, for example, the following expression.

Next frame position NFP=current frame position CFP+play rate/225

The play rate in the above expression indicates the play speed of the phrase. The user can designate the play rate, for example, by operating the operation unit 210. For example, if the current frame position CFP is the value 10 and the play rate is the velocity indicated by the value 450, the value 12 is calculated as the next frame position NFP. That is, the frame position after the current frame position CFP is calculated as the next frame position NFP. The play rate may be referred to as the play speed.

The processor 200 determines whether the next frame position NFP calculated in step S305 is a frame position after the vowel end frame F3 of the current syllable (step S306). If it is not a frame position after the vowel end frame F3 (step S306: NO), the processor 200 sets the next frame position NFP as the current frame position CFP (step S307). If it is a frame position after the vowel end frame F3 (step S306: YES), the processor 200 sets the vowel end frame F3 as the current frame position CFP (step S308).

After executing steps S307 and S308, the processor 200 executes the vocal generation of step S203 of FIG. 7. The processing of steps S101, S102, and S104 of FIG. 6 are repeatedly executed as long as the first key is pressed. More specifically, in the key press processing illustrated in FIG. 8, steps S304 to S307 are repeatedly executed in the period until proceeding to the next syllable. That is, the frame position in the current syllable proceeds. As a result of the proceed of the frame position in the current syllable, the vowel end frame F3 is set as the current frame position CFP in step S308. In step S304 executed thereafter, the processor 200 determines to proceed the syllable.

If proceeding to the next syllable (step S304: YES), the processor 200 determines whether the current syllable to be generated is the last syllable in the phrase (step S309). If it is the last syllable in the phrase (step S309: YES), the processor 200 executes consonant offset processing on the initial syllable in the phrase (step S310). If it is not the last syllable in the phrase (step S309: NO), the processor 200 executes the consonant offset processing on the next syllable in the phrase (step S311). It is also determined as YES in step S309 when the processing of step S309 is executed for the first time on the phrase to be played (that is, when the initial syllable in the phrase is played for the first time after the key press on the first key).

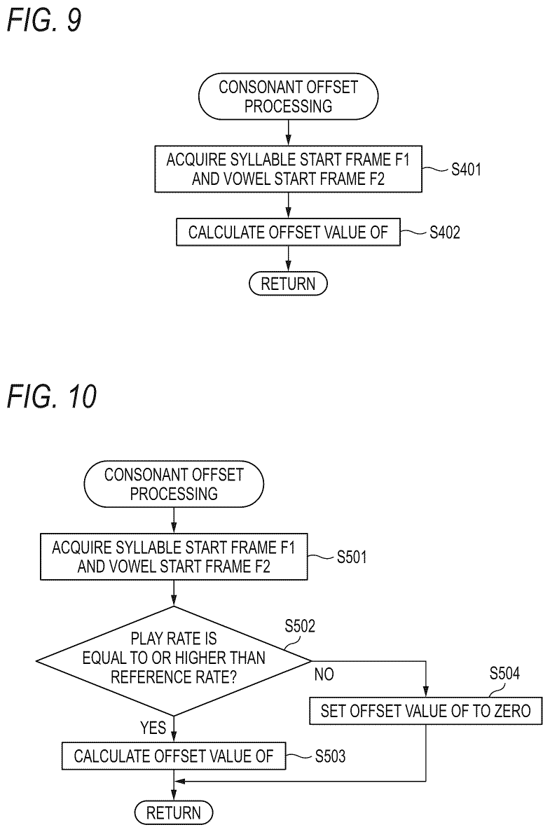

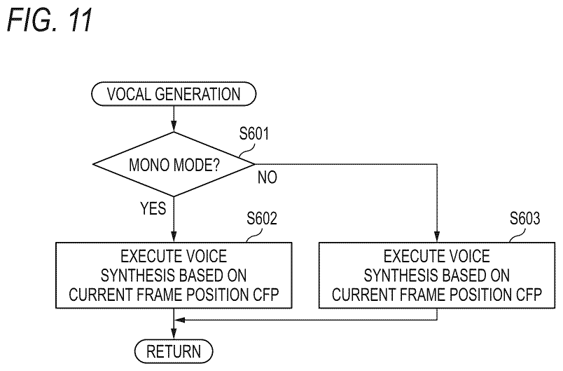

Two examples of the consonant offset processing of steps S310 and S311 will be described with reference to FIGS. 9 and 10. FIG. 9 is a subroutine illustrating the details of the consonant offset processing according to Embodiment 1. FIG. 10 is a subroutine illustrating the details of the consonant offset processing according to Embodiment 2. The consonant offset processing of step S310 will be described below. In this description, the consonant offset processing of step S311 can be described by replacing “initial syllable” with “next syllable”. To avoid redundant description, the description of the consonant offset processing of step S311 will be omitted.

As illustrated in FIG. 9, in Embodiment 1, the processor 200 acquires the syllable start frame F1 and the vowel start frame F2 of the initial syllable in the phrase (step S401).

The processor 200 acquires a value for changing the length of the consonant included in the initial syllable using the syllable start frame F1 and the vowel start frame F2 acquired in step S401 (step S402). For example, the processor 200 calculates an offset value OF for changing the length of the consonant using the following expression.

Offset value OF=(vowel start frame F2−syllable start frame F1)×adjustment value/100%

The adjustment value of the above expression is an example of a parameter (more specifically, an example of a parameter including a ratio), and takes, for example, a value of 0 to 100 (unit: %) (in other words, a ratio). The operation unit 210 (for example, the consonant length adjustment knob 210A) is an example of an operator for changing the length of a consonant, and designates an adjustment value (a ratio from 0% to 100%) in response to a user operation. An adjustment value designated higher indicates a larger offset value OF. In other words, an adjustment value designated larger indicates a shorter length of the consonant in the syllable.

That is, the processor 200 changes the lengths of the plurality of consonants based on a parameter (the above-described adjustment value) designated in response to one user operation (for example, one user operation on the consonant length adjustment knob 210A). In addition, the processor 200 changes the lengths of a plurality of consonants to lengths shorter than the original lengths based on a ratio (for example, a ratio from 0% to 100%) designated in response to the user operation on an operator for changing a length of a consonant (the consonant length adjustment knob 210A). By uniformly changing the lengths of the plurality of consonants in the phrase by a single user operation in accordance with the user's preference, the user can perform more preferable vocal generation of the phrase.

If the syllable does not contain a consonant (for example, “a”, “i”, “u”. “e”, “o”), the syllable start frame F1 and the vowel start frame F2 are the same, and the value of (vowel start frame F2−syllable start frame F1) becomes zero. Therefore, the sound to be generated does not change even if the offset value OF is applied to the syllable without a consonant. That is, the processor 200 does not change the vocal generation start timing of the vowel in the syllable without a consonant, regardless of the parameters designated in response to one user operation.

As illustrated in FIG. 10, in Embodiment 2, the processor 200 acquires the syllable start frame F1 and the vowel start frame F2 of the initial syllable in the phrase (step S501).

The processor 200 determines whether the play rate is equal to or higher than the reference rate (step S502).

If the play rate is equal to or higher than the reference rate (step S502: YES), the processor 200 acquires a value for changing the length of the consonant included in the initial syllable using the syllable start frame F1 and the vowel start frame F2 acquired in step S501 (step S503). For example, the processor 200 calculates an offset value OF for changing the length of the consonant using the following expression.

Offset value OF=(vowel start frame F2−syllable start frame F1)×10×(play rate−reference rate)/(255−reference rate)

The reference rate in the above expression is a rate at which the singing voice is played at a standard speed (for example, a speed of 1.0 times), and takes a predetermined value. A higher play rate relative to the reference rate indicates a larger offset value OF. In other words, a play rate designated higher indicates a shorter length of the consonant in the syllable.

If the play rate is lower than the reference rate (step S502: NO), the processor 200 sets the offset value OF to zero (step S504). In this case, in a syllable applied with the offset value OF, the length of the consonant remains the same as the original length.

The description returns to FIG. 8. The processor 200 sets a frame position offset from the syllable start frame F1 of the initial syllable in response to the offset value OF calculated in step S310 as the next frame position NFP (step S312), sets this next frame position NFP as the current frame position CFP (step S307), and ends the key press processing of FIG. 8.

In step S313, similarly to step S312, the processor 200 sets a frame position that is offset from the syllable start frame F1 of the next syllable in response to the offset value OF calculated in step S311 as the next frame position NFP, sets this next frame position NFP as the current frame position CFP in step S307, and ends the key press processing of FIG. 8.

FIG. 5B is a diagram for explaining the effect exerted in the embodiment of the present invention. As an effect achieved by executing the key press processing in FIG. 8, FIG. 5B illustrates that the difference in the length of the consonants in the syllables included in the phrases “ka” and “shi” is shorter than in the example in FIG. 5A. FIG. 5B is also attached with a schematic diagram illustrating that the consonant length adjustment knob 210A is set to the value 50 (adjustment value: 50%). In addition, in FIGS. 5A and 5B, to visually illustrate the above effect, the frames from the syllable start frame F1 to the vowel start frame F2 of “ka” are hatched, and the frames from the syllable start frame F1 to the vowel start frame F2 of “shi” are hatched.

In the example of FIG. 5A, the syllable start frame F1 of “ka” is the initial frame within the syllable “ka”, and the vowel start frame F2 of “ka” is the 11th frame within the syllable “ka”. The syllable start frame F1 of “shi” is the initial frame within the syllable “shi”, and the vowel start frame F2 of “shi” is the 21st frame within the syllable “shi”. Therefore, the difference in length between the consonant of the syllable “ka” and the consonant of the syllable “shi” is 10 frames (for example, 50 msec). Here, consider a case where the adjustment value is set to 50% by the user rotating the consonant length adjustment knob 210A from the value zero (adjustment value: 0%)illustrated in FIG. 5A to the value 50 (adjustment value: 50%) illustrated in FIG. 5B.

In this case, for example, the offset value OF for the syllable “ka” calculated in step S402 in FIG. 9 is (11-1)×50%/100%, that is, the value 5. The offset value OF for the syllable “shi” is (21-1)−50%/100%=10.

Therefore, by executing steps S312 and S307, for “ka”, a position offset to 5 frames before the vowel start frame F2 (11th frame), that is, the sixth frame within the syllable, is set as the current frame position CFP. Thus, the period in which the consonant included in the syllable “ka” is played is shortened from the period of 10 frames obtained by subtracting the value 1 from the value 11 to the period of five frames obtained by subtracting the value 6 from the value 11. Also, by executing steps S313 and S307, for the syllable “shi”, a position offset to frames before the vowel start frame F2(21st frame), that is, the 11 th frame within the syllable, is set as the current frame position CFP Thus, the period in which the consonant included in the syllable “shi” is played is shortened from the period of 20 frames obtained by subtracting the value 1 from the value 21 to the period of 10 frames obtained by subtracting the value 11 from the value 21.

That is, as illustrated in FIG. 5B, the difference between the lengths of consonants included in the syllables “ka” and “shi” is shortened from the length of 10 frames (for example, 50 msec) to the length of five frames (for example, 25 msec). That is, the processor 200 reduces the difference between the lengths of the plurality of consonants based on a parameter (for example, adjustment value: 50%) designated in response to one user operation (for example, a user operation of rotating the consonant length adjustment knob 210A from the value zero to the value 50). As a result, the difference in the rise of generation of “ka” and “shi” is reduced.

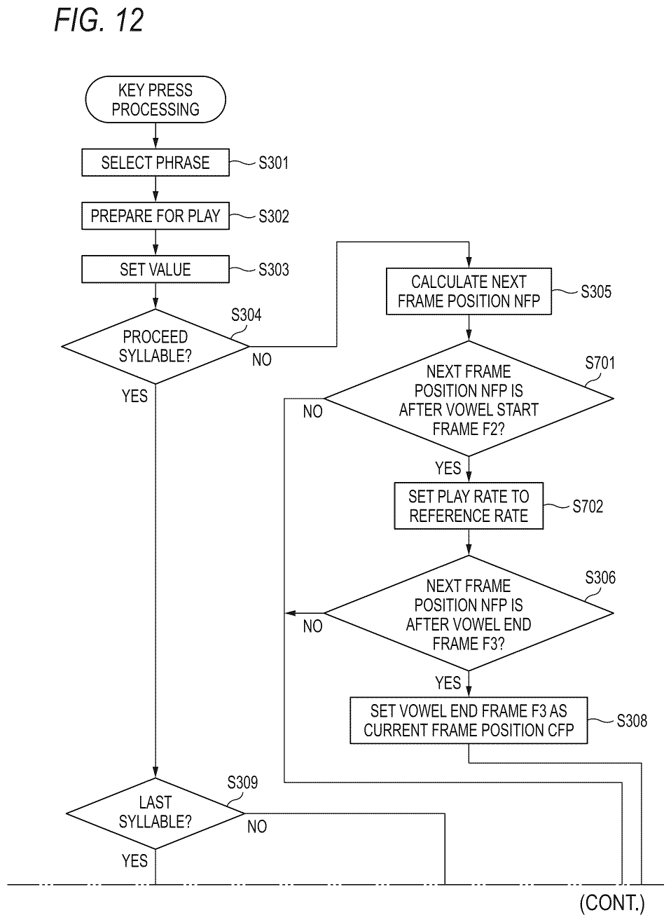

FIG. 11 is a subroutine illustrating the details of the vocal generation of step S203 of FIG. 7. The vocal generation illustrated in FIG. 11 is executed by, for example, the vocalization model unit 330 implemented by the control of the processor 200.

If set to the mono mode (step S601: YES), the processor 200 acquires the sound source parameters 452 and the spectrum parameters 454 including the fundamental frequency (F0) and the lyrics parameters 424 based on the current frame position CFP set in step S307 of FIG. 8, generates and excites the sound source signal 460, and outputs the singing voice output data 500 (step S602). If set to the poly mode (step S601: NO), the processor 200 acquires waveform data corresponding to the spectrum parameters 454, the lyrics parameters 424, and the pitch data and the tone corresponding to the pressed key based on the current frame position CFP set in step S307 of FIG. 8, generates and excites the sound source signal based on the waveform data, and outputs the singing voice output data 500 (step S603).

The singing voice is played based on the singing voice output data 500 output in this manner. By performing the offset processing according to the offset value OF, the difference in the length of the consonant for each syllable is reduced. As a result, the difference in the rise of generation of each syllable is limited small. Therefore, for example, the user can easily perform on the keyboard while maintaining a constant rhythm and proceeding the lyrics. In the singing voice generation mode, for example, the user can perform a singing voice with the same feeling as in the case of keyboard performance in the normal mode.

In addition, the present invention is not limited to the above-described embodiment, and various modifications can be made without departing from the gist of the present invention in the implementation stage. Further, the functions executed in the above-described embodiments may be appropriately combined where appropriate. The above-described embodiment includes various stages, and various inventions can be extracted by appropriately combining a plurality of the disclosed constituent elements. For example, even if some components are deleted from all the components disclosed in the embodiments, a configuration in which the components are deleted can be extracted as an invention as long as the effect can be obtained.

In the above-described embodiment, the lyrics data 420, which is an example of information on the lyrics, includes a first syllable (for example, a syllable “ka”) and a second syllable (for example, a syllable “shi”) that is generated after the first syllable on the timeline. The processor 200 executes the singing voice generation mode according to a predetermined control signal (according to the control signal generated in response to the setting operation to the singing voice generation mode), and changes both the length of the first consonant and the length of the second consonant such that the difference between the length of the first consonant included in the syllable “ka” and the length of the second consonant included in the syllable “shi” becomes smaller. In other words, in the above-described embodiment, both the length of the first consonant and the length of the second consonant are changed to a length shorter than the original length.

On the other hand, in another embodiment, the length of one of the first consonant and the second consonant may be changed alone to reduce the difference between the length of the first consonant and the length of the second consonant. For example, consider a case where the consonant of the syllable “shi” is longer than the consonant of the syllable “ka” by 10 frames (for example, 50 msec). In this case, the processor 200 executes the offset processing corresponding to the offset value OF only on the syllable “shi”. As an example, by offsetting the syllable “shi” by 10 frames, the consonant lengths of the syllable “ka” and the syllable “shi” become the same. In this case, the difference in the rise of generation of each syllable is further reduced, and the consonant can be generated in the syllable “ka” in the original state without changing the length of the consonant.

In this way, the scope of the present invention also includes a configuration in which one of the length of the first consonant and the length of the second consonant is changed to a length shorter than the original length.

In the above-described embodiment, both the length of the first consonant included in the first syllable (for example, the syllable “ka”) and the length of the second consonant included in the second syllable (for example, the syllable “shi”) are changed to a length shorter than the original length by the same ratio (for example, the adjustment value of 50%), but the configuration of the present invention is not limited thereto.

The length of the first consonant and the length of the second consonant may be changed to lengths shorter than the original lengths at different ratios. For example, in the above-described embodiment, consider a case where the adjustment value for the syllable “ka” is 10% and the adjustment value for the syllable “shi” is 50%. In this case, the period in which the consonant included in the syllable “ka” is played is shortened from the period of 10 frames to the period of 9 frames. The period in which the consonant included in the syllable “shi” is played is shortened from the period of 20 frames to the period of 10 frames.

That is, the difference between the lengths of the consonants included in the syllables “ka” and “shi” is shortened from the length of 10 frames (for example, 50 msec) to the length of one frame (for example, 5 msec). As a result, the difference between the rise of generation of “ka” and “shi” can be further limited small.

Specific syllables (for example, a syllable including a consonant s or y), although depending on the influence of the context, have a consonant basically longer than other syllables. In this case, the processor 200 may change the length of the consonant included in such specific syllable in the lyrics data 420 to a length shorter than the original length. In the example of FIG. 5A, the processor 200 may change the length of the consonant included in the syllable “shi” to a length shorter than the original length. In this case as well, since the difference in the length of the consonant between the syllable “ka” and the syllable “shi” is shortened, the difference in the rise of generation of each syllable is limited small.

For example, consider a case where the consonant of the syllable “ka” is shorter than the consonant of the syllable “shi” by 10 frames (for example, 50 msec). In this case, the processor 200 increases the length of the consonant by 10 frames for only the syllable “ka”. Accordingly, the lengths of the syllable “ka” and the length of the consonant of the syllable “shi” become the same. Therefore, the difference in the rise of generation of each syllable is limited small. In the syllable “shi”, the consonant can be generated in the original state without changing the length of the consonant.

Next, a modification of the key press processing of step S202 of FIG. 7 will be described. FIG. 12 is a subroutine illustrating the details of the key press processing according to a modification of the present invention. In the key press processing illustrated in FIG. 12, the same processing as the key press processing illustrated in FIG. 8 is as steps denoted by the same reference signs, and the description thereof will be appropriately omitted.

As illustrated in FIG. 12, after executing the processing of steps S301 to S305, the processor 200 determines whether the next frame position NFP calculated in step S305 is a frame position after the vowel start frame F2 of the current syllable (step S701). If it is a frame position before the vowel start frame F2 (step S701: NO), the processor 200 sets the next frame position NFP as the current frame position CFP (step S307).

If the next frame position NFP calculated in step S305 is a frame position after the vowel start frame F2 of the current syllable (step S701. YES), the processor 200 sets the play rate to the reference rate (step S702). Next, the processor 200 determines whether the next frame position NFP is a frame position after the vowel end frame F3 (step S306). If it is not a frame position after the vowel end frame F3 (step S306: NO), the processor 200 sets the next frame position NFP as the current frame position CFP (step S307). If it is a frame position after the vowel end frame F3 (step S306: YES), the processor 200 sets the vowel end frame F3 as the current frame position CFP (step S308).

That is, in the modification, the syllable (more specifically, the vowel included in the syllable) is played at the reference rate from the vowel start frame F2 to the vowel end frame F3. In the modification, the reference rate may be referred to as a reference play speed.

If proceeding to the next syllable (step S304: YES), the processor 200 executes play rate acquisition for the initial syllable in the phrase (step S703) if the current syllable to be generated is the last syllable in the phrase (step S309: YES). If it is not the last syllable in the phrase (step S309: NO), the processor 200 executes the play rate acquisition on the next syllable in the phrase (step S704).

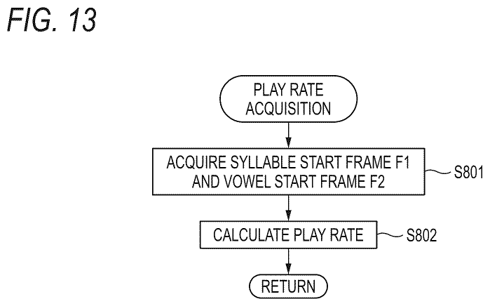

FIG. 13 is a subroutine illustrating the details of the play rate acquisition of steps S703 and S704 of FIG. 12. The play rate acquisition of step S703 will be described below. In this description, the play rate acquisition of step S704 can be described by replacing “initial syllable” with “next syllable”. To avoid redundant description, the description of the play rate acquisition of step S704 will be omitted.

As illustrated in FIG. 13, the processor 200 acquires the syllable start frame F1 and the vowel start frame F2 of the initial syllable in the phrase (step S801).

The processor 200 acquires a value for changing the length of the consonant included in the initial syllable using the syllable start frame F1 and the vowel start frame F2 acquired in step S801 (step S802). For example, the processor 200 calculates a play rate for changing the length of the consonant using the following expression.

Play rate=reference rate+[(225−reference rate)−(vowel start frame F2−syllable start frame F1)/consonant length MAX]

The consonant length is, for example, information included in the lyrics parameters 424, and indicates the length of the consonant of each syllable. The consonant length MAX in the above expression indicates the length of the longest consonant in all the syllables included in the phrase. In the example of FIG. 5A, the length of the consonant included in the syllable “shi” corresponds to the consonant length MAX.

The description returns to FIG. 12. After executing the play rate acquisition for the initial syllable in the phrase (step S703), the processor 200 sets the syllable start frame F1 of the initial syllable as the next frame position NFP (step S705), sets this next frame position NFP as the current frame position CFP (step S307), and ends the key press processing of FIG. 12.

After executing the play rate acquisition for the next syllable in the phrase (step S704), the processor 200 sets the syllable start frame F1 of the next syllable as the next frame position NFP (step S706), sets this next frame position NFP as the current frame position CFP (step S307), and ends the key press processing of FIG. 12.

By repeatedly executing the key press processing of FIG. 12 during the key press, in the modification, until the syllable start frame F1 reaches the vowel start frame F2, a consonant included in a syllable is played at a play rate faster than the reference rate calculated in the play rate acquisition of step S703 and S704,a and a vowel following the consonant is played at the reference rate lower than a play rate.

For example, in the modification, the processor 200 makes faster than the consonants included in the syllables “ka” and “shi”, thereby playing the consonant included in the syllable “ka” and the consonant included in the syllable “shi” in a time shorter than the original lengths (time). In the modification as well, since the difference in the lengths of the consonants of the syllables is shortened, the difference in the rise of generation of each syllable is limited small.

In the modification, the play rate designated by the user operation on the operation unit 210 (for example, one user operation on the consonant length adjustment knob 210A) is an example of a parameter for designating the play speed. That is, in the modification, the processor 200 makes the play speed of the data corresponding to the first consonant (for example, the voice data indicating the consonant included in the syllable “ka”) and the play speed of the data corresponding to the second consonant (for example, the voice data indicating the consonant included in the syllable “shi”) faster than the reference play speed (reference rate) based on the parameter for designating the play speed.

As described above, the scope of the present invention also includes a configuration in which the processor 200 changes one of the length of the first consonant and the length of the second consonant to a length shorter than the original length, by making one of the play speed of the first consonant and the play speed of the second consonant faster than the reference play speed in accordance with the predetermined control signal.

In the description so far, the difference in length between consonants in each syllable is shortened by setting the lengths of the consonants shorter than the original lengths, but the configuration of the present invention is not limited thereto. The scope of the present invention also includes a configuration of shortening the difference in the lengths of the consonants of each syllable by setting the lengths of the consonants longer than the original lengths.

The present application is based on a Japanese Patent Application No. 2021-207131 filed on Dec. 21, 2021, and contents thereof are incorporated herein by reference.

### INDUSTRIAL APPLICABILITY

According to the present invention, it is possible to provide a consonant length adjustment device by which a difference in the rise of generation of each syllable can be limited small.

### REFERENCE SIGNS LIST

1: Musical instrument system
10: Electronic musical instrument
20: Information processing device
100: Processor
102: RAM
104: Flash ROM
106: LCD
108: LCD controller
110: Keyboard
112: Switch panel
114: Key scanner
116: Network interface
118: Sound source LSI
120: D/A converter
122: Amplifier
124: Speaker
126: Bus
150: Music stand
200: Processor
202: RAM
204: Flash ROM
206: LCD
208: LCD controller
210: Operation unit
212: Network interface
214: D/A converter
216: Amplifier
218: Speaker
300: Functional block group
310: Processing unit
320: Acoustic model unit
330: Vocalization model unit
332: Sound source generation unit
334: Synthesis filter unit

1-8. (canceled)

9. A consonant length changing device comprising at least one processor, the at least one processor being configured to perform:
in accordance with one user operation, designating a parameter;
based on the parameter, advancing a first vocal generation start timing of a first vowel in one syllable including a first consonant and the first vowel and advancing a second vocal generation start timing of a second vowel in another syllable including a second consonant and the second vowel; and
not advancing a vocal generation start timing of a vowel in a syllable without including a consonant based on the parameter.

10. The consonant length changing device according to claim 9, wherein the parameter includes a ratio, and
wherein the at least one processor respectively changes lengths of a plurality of consonants to lengths shorter than original lengths based on the ratio designated in response to the user operation on an operator for changing a length of a consonant.

11. The consonant length changing device according to claim 10, wherein the at least one processor performs reducing a difference between lengths of the plurality of consonants.

12. The consonant length changing device according to claim 9, wherein the parameter is a parameter for designating a play speed, and
wherein the at least one processor makes a play speed of data corresponding to the first consonant and a play speed of data corresponding to the second consonant faster than a reference play speed based on the parameter designating the play speed.

13. The consonant length changing device according to claim 12, wherein
the at least one processor performs reducing a difference between lengths of the plurality of consonants.

14. The consonant length changing device according to claim 9, wherein the one user operation is a user operation on a constant length adjustment operator for changing a length of a consonant, and
wherein the at least one processor uniformly changes lengths of all consonants in a phrase based on the parameter.

15. An electronic musical instrument comprising:
the consonant length changing device according to claim 9, and
a performance operator.

16. A musical instrument system comprising:
a consonant length changing device configured to output parameters in which lengths of a plurality of consonants are changed respectively based on one user operation; and
an electronic musical instrument including a processor configured to:
acquire the parameters output from the consonant length changing device; and
output singing voice output data based on the acquired parameters.

17. A method comprising causing at least one processor of a consonant length changing device to perform:
in accordance with one user operation, designating a parameter;
based on the parameter, advancing a first vocal generation start timing of a first vowel in one syllable including a first consonant and the first vowel and advancing a second vocal generation start timing of a second vowel in another syllable including a second consonant and the second vowel; and
not advancing a vocal generation start timing of a vowel in a syllable without including a consonant based on a parameter.

18. The method according to claim 17, wherein the parameter includes a ratio, and
wherein the method causes the at least one processor respectively to change lengths of a plurality of consonants to lengths shorter than original lengths based on the ratio designated in response to the user operation on an operator for changing a length of a consonant.

19. The method according to claim 18, wherein the method causes the at
least one processor to perform reducing a difference between lengths of the plurality of consonants.

20. The method according to claim 17, wherein the parameter is a parameter for designating a play speed, and
wherein the method causes the at least one processor to make a play speed of data corresponding to the first consonant and a play speed of data corresponding to the second consonant faster than a reference play speed based on the parameter designating the play speed.

21. The method according to claim 20, wherein the method causes the at
least one processor to perform reducing a difference between lengths of the plurality of consonants.

22. The method according to claim 17, wherein the one user operation is a user operation on a constant length adjustment operator for changing a length of a consonant, and
wherein the method causes the at least one processor to uniformly change lengths of all consonants in a phrase based on the parameter.
